(19) United States
(12) Patent Application Publication
(10) Pub. No.: US 2004/0032071 A1
(43) Pub. Date: Feb. 19, 2004

(54) Vise jaw quick change

(76) Inventor: Arthur L. Garrison, Rogers, AR (US)

Correspondence Address: ARTHUR L. GARRISON, 20410 LAKEVIEW DR., ROGERS, AR, 72756, US

(21) Appl. No.: 10/224,198

(22) Filed: Aug. 19, 2002

(51) Int. Cl. B25B 1/24

(52) U.S. Cl. 269/283

(57) ABSTRACT

A jaw plate with parallel and opposing flat surfaces one surface having a specially machined detail that when mated with matching adapters hold said jaw plate by spring tension against a flat surface while urging said jaw plate against a stationary hard stop on said adapter while simultaneously urging said jaw plate against the floor of a gripping device such as a machine vise.

### BACKGROUND

1. Field of Invention

This invention relates to a quick change vise jaw, specifically to a quick change vise jaw, that may be tapped on and off with a soft hammer.

2. Description of Prior Art

Development of CNC (computer numerical control) machines has brought new capabilities, and new needs, to the machine industry. CNC machines have the ability to perform programmable tasks with predictable precision and repeatability.

Because CNC machines are very expensive, in order to cost justify them, the cutter must remain in the work piece as much as possible. Likewise the spindle must remain idle as little as possible. To this end, the so called “set up time”, more recently referred to as “change over time”, must be held to a minimum. In order to reduce “change over time”, many shops are utilizing soft jaws sometimes called machineable jaws. Many times these can replace costly fixtures that are much more time consuming to set up. Machineable jaws are well known. However, in order to change them on conventional vises the mounting bolts must be removed. This is a slow and frustrating operation because the mounting bolts are within the clamping area of the vise and are difficult to remove and replace due to their restricted access location. Jaws mounted with bolts do not have the ability to repeat with an acceptable degree of precision. This inability to precisely repeat location is not in harmony with the modem CNC machines ability to locate quickly and precisely.

There is some prior art that addresses this problem by use of, so called, quick change jaws. U.S. Pat. No. 4,602,772 Stanley w. Wright and Larry L. Horn, Jul. 29, 1986 shows an embodiment that utilizes a clamp that is drawn tight on a removable jaw. This embodiment makes use of the same troublesome interior jaw bolts as the standard jaws, thus nullifying much of the desired advantage. This embodiment exposes the mating joints, and the bolt cavities to machining debris. Since the embodiment Depends on the jaw bolts for longitudinal location there is no means for precisely locating the jaw for repeat ability, such as a “hard stop”.

U.S. Pat. No. 4,706,949 Dossey; Robert L. Nov. 17, 1987 reveals an embodiment that utilizes a three piece arrangement. The first member replaces the fixed jaw on the vise, and has a gripping member that is drawn tight by a bolt. This bolt is awkward to get to, being on the back of the vise. The bolt is exposed to machining debris.

The second member serves as a jaw receiver through which bolts hold the working jaw in place. There is a machined area that mates between the working jaw and the jaw holder. The degree of precision repeat ability is dependent of the degree of precision machined into these mating members. U.S. Pat. No. 4,960,270 Fitzpatrick: John P. Oct. 2, 1990 Discloses an embodiment wherein a “quick change jaw” is secured by tee slots machined into the working jaw that are clamped by “low head” bolts. A disadvantage of this arrangement is that there is no provision for precise repeatable location, because the location is dependent on the bolts, and is not very precise. This embodiment leaves the key access hole exposed to machining debris.

U.S. Pat. No. 5,921,536 Leon M. Bernstein, Assignee: Kurt Manufacturing. Jul. 13, 1999, Discloses an arrangement similar to Fitzpatrick, but adds the ability to reverse the jaw. This embodiment has the same problems (no precise repeat ability, exposure to machining debris.) All of these prior art embodiments that are secured by bolts limit the useable portion of the jaw due to the space that the bolt takes up.

### OBJECTS AND ADVANTAGES

Several objects and advantages of the present invention are:

(a) Retention bolts are eliminated, removing the need for tools, keys and Time to loosen or remove them.

(b) By eliminating the bolts an area for machining debris is also eliminated.

(c) By eliminating the bolts, more of the jaw is available for machining.

(d) Predictable, repeatable precise positioning by use of a “hard stop”.

(e) No holes, cavities, or openings exposed to debris.

(f) Very fast simple installation and removal with only a soft hammer.

Although well suited to machine vises, the present invention is by no means limited to this embodiment. One such embodiment would be a gripping jaw arrangement on other types of gripping or clamping mechanisms used in machining. Another such embodiment might be for any fixture or appliance that requires quick removal and replacement. Another such embodiment would be replacement of wear plates and such. This is by no means an extensive list of possible embodiments. Further objects and advantages will become apparent from the following description and drawings.

### DRAWING FIGURES

FIG. 1 Shows a prior art application of standard vise jaws.

FIG. 2 Shows elements to convert a common vise to use “top on” Quick change jaws.

FIG. 3 Shows a method for installing the quick change jaw.

FIG. 4 Shows machining details in the jaw.

FIG. 5 Shows is an oblique view of the machined details.

FIG. 6 Shows an adapter nesting in the internal machined jaw detail.

FIG. 7 Shows an exploded view of the adapter assembly and the jaw.

FIG. 8 Shows an expanded view of the locking jaw detail.

### REFERENCE NUMERALS IN DRAWINGS

10 Vise

20 Standard vise jaw

30 Jaw bolts

40 Quick change jaw

50 Adapter assembly

60 Soft hammer

70 Adapter housing

80 Spring loaded jaw retainer

90 Retainer spring

100 Retainer screw

110 Fixed (hard stop dia) of adapter housing

120 Detention recess

130 Inclined ramp area of locking detail 140

140 Locking, or retention detail

### SUMMARY

In accordance with the present invention, Vise jaw, Quick Change Vise jaws are driven against a spring loaded retainer. As the jaw is driven on the vise said spring loaded retainer is urged up an inclined ramp in a specially machined retaining detail until it reaches a detent recess area of the retaining detail. Once the jaw advances to the retention recessed area the spring retainer “snaps” into the detent recess affixing the jaw against a stationary hard stop, against the face of the vise, and against the floor of the vise simultaneously. This is accomplished by the precise mating of the spring loaded retainer and the specially machined retaining detail, affixing the jaw in a repeatable position.

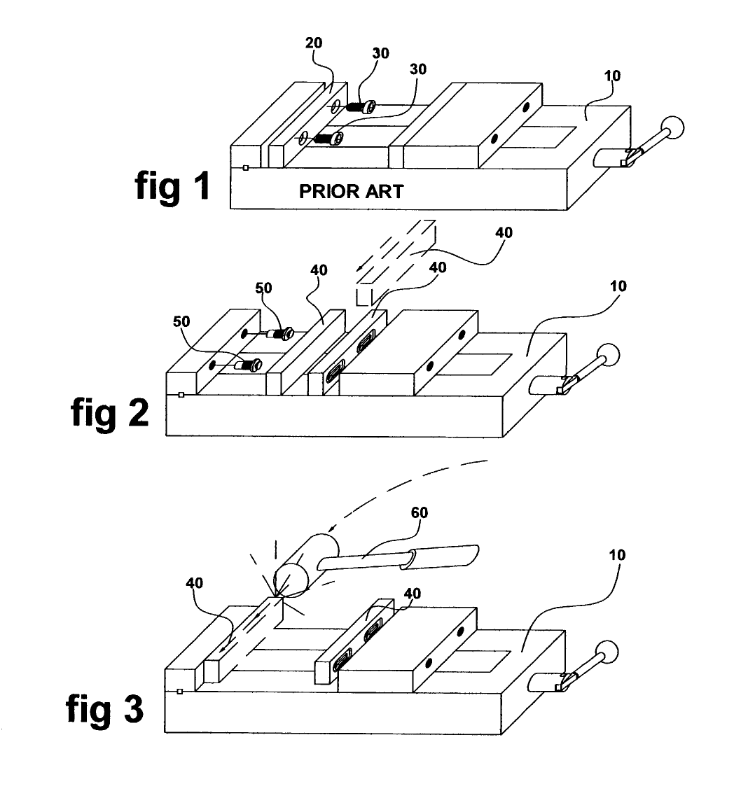

### Description FIGS. 1 Through 8

According to the preferred embodiment of the present invention,

FIG. 1 Shows prior art, a Vise 10 is fitted with removable jaws 20 retained by jaw bolts 30.

FIG. 2 shows a vise 10 adapters 50 that replace the jaw bolts and retain the quick change jaws 40.

FIG. 3 shows a method of installing the quick change jaw 40 onto a vise 10 by tapping it onto the spring retainer with a soft hammer 60.

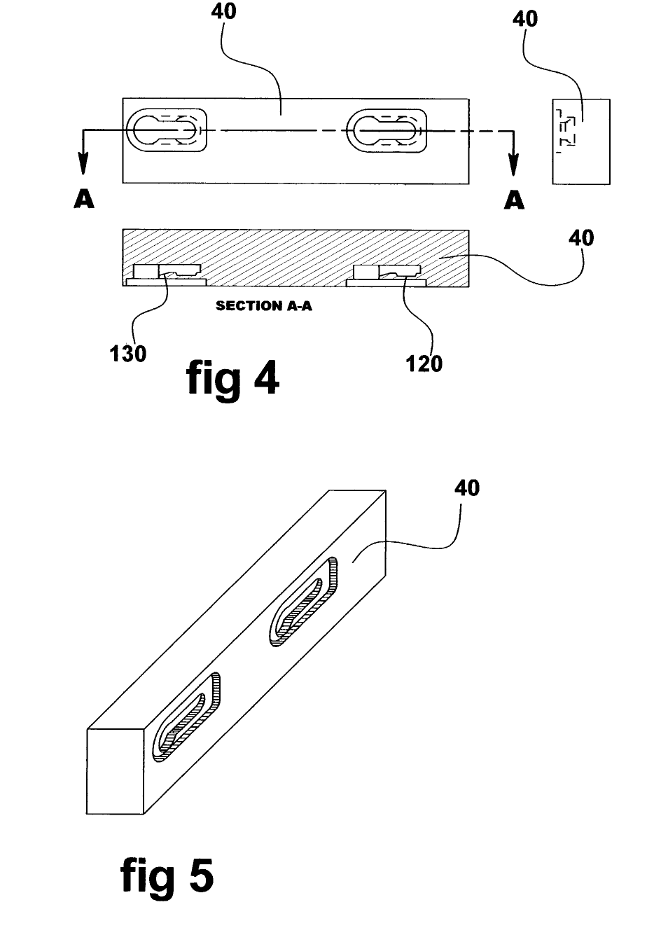

FIG. 4 shows a quick change jaw 40 with section A-A depicting internal machined detail for mating with the adapters.

FIG. 5 shows a quick change jaw 40 that depicts another view of the machined retaining detail.

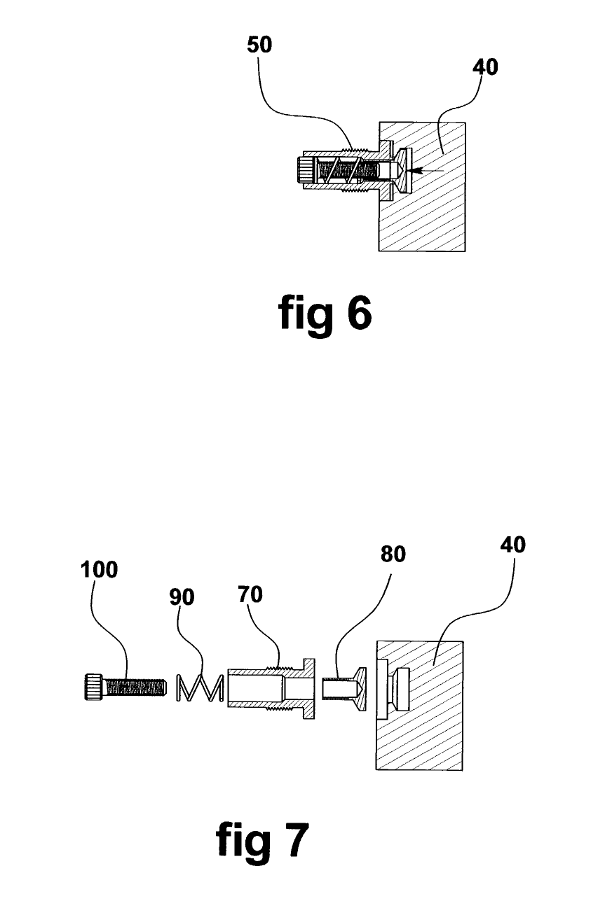

FIG. 6 shows an adapter assembly 50 installed into a quick change jaw 40.

FIG. 7 shows quick change jaw 40, jaw retainer 80, adapter housing 70, spring 90 and spring retainer screw 100.

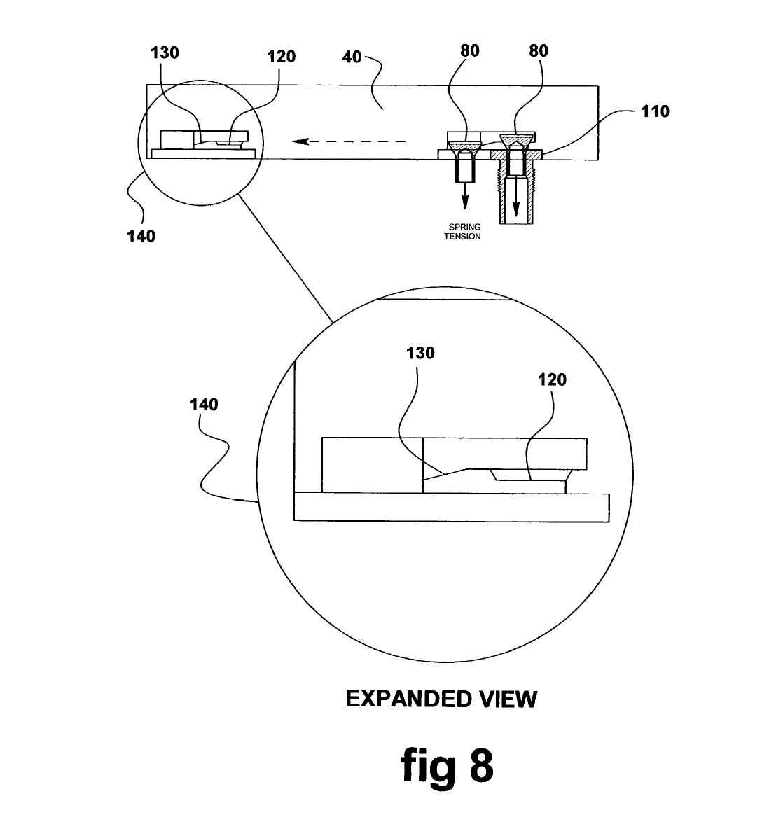

FIG. 8 shows an expanded view of the machined locking detail 140, an inclined ramp 130, detention recess 120 machined into quick change jaw 40. spring loaded retainer 80 hard stop diameter on adapter housing.

### Operation and use FIGS. 1 Through 3

Use of the preferred embodiment: FIG. 1 The standard jaws 20 and jaw bolts 30 Are replaced by adapters FIG. 2 element 50. quick change jaw 40 is staged in installation position FIG. 3 and tapped into its retained position with soft hammer 60 seating jaw against “hard stop” diameter of adapter 50 seating the spring loaded retainer 80 into the detent recess 120 removal simply requires tapping the jaw off in the opposite direction.

### Conclusions, Ramifications, and Scope

Accordingly the reader will see that the Quick change vise jaw can be used in a variety of embodiments and applications. The simplicity of the invention allows for broader usage than that of vise jaws. Furthermore the quick change jaws have additional advantages in that:

a. they are very simple and economical to manufacture.

b. They are very fast to install and remove.

c. They have no bolts or openings to collect debris.

d. They have no bolts to restrict machining

e. They will repeat location with great precision against a hard stop

Although the above description contains many specifics, these should not be construed as limiting the scope of the invention but as merely providing illustrations of some of the presently preferred embodiments of the invention. Thus the scope of the invention should be determined by the appended claims and their legal equivalents, rather than by the examples given.

I claim:

1. A jaw plate comprising a block having top bottom and end surfaces having opposing flat faces one face having a means for fastening said jaw plate to another flat surface.

2. A jaw plate of claim 1 having a specially machined detail for fastening said jaw plate to a flat surface.

3. A jaw plate of claim 2 wherein said specially machined detail is configured to accept an adapter for fastening said jaw plate to another flat surface.

4. An adapter of claim 3 wherein said adapter furnishes a means to affix said jaw plate to said flat surface.

5. An adapter of claim 4 wherein said adapter affixes said jaw plate to said flat surface by means of a spring retainer urging said jaw against said flat surface.

6. An adapter of claim 5 wherein said adapter with spring tension urges said jaw plate against a stationary surface of said adapter.

7. A jaw plate of claim one wherein said jaw plate is retained in place by said spring tension adapter of claim 6 against said stationary surface of said adapter also against flat surface.

8. A jaw plate of claim 1 wherein said jaw plate is urged against the floor of a vise against said stationary surface of said adapter and against said flat surface by said spring tensioning adapter and said specially machined retaining configuration of claim 2.
